(19) United States
(12) Patent Application Publication
(10) Pub. No.: US 2016/0037908 A1
(43) Pub. Date: Feb. 11, 2016

(54) WORKING STATION

(71) Applicant: ZVIKA KANONICH, CAESAREA (IL)

(72) Inventor: ZVIKA KANONICH, CAESAREA (IL)

(21) Appl. No.: 14/819,459

(22) Filed: Aug. 6, 2015

Related U.S. Application Data
(60) Provisional application No. 62/034,180, filed on Aug. 7, 2014.

(51) Int. Cl. A47B 13/08; A47B 9/00; A47B 37/04

(52) U.S. Cl. CPC A47B 13/081; A47B 37/04; A47B 13/088; A47B 9/00

(57) ABSTRACT

A working station having a base, a table extending from the base, the table having at least two subsidiary tables, where each of the at least two subsidiary tables is independently tiltable and elevatable in relation to the base, thereby the at least two subsidiary tables are adaptable for impaired persons.

### CROSS-REFERENCE TO RELATED APPLICATIONS

This application claims the benefit of priority from U.S. Provisional Patent Application No. 62/034,180, filed Aug. 7, 2014, the disclosure of which is incorporated herein by reference.

### TECHNICAL FIELD

The invention relates to the field of therapeutic employment, especially for impaired persons. More particularly, the invention relates to a method and workstation for producing contained basic plants, especially for therapeutic employment.

### BACKGROUND

A plant nursery is a place where plants are propagated and grown to usable size. They include retail nurseries which sell to the general public, whole sale nurseries which sell only to businesses such as other nurseries and to commercial gardeners, and private nurseries which supply the needs of institutions or private estates.

The term “contained basic plant” refers herein to a plant being contained in a raw container, produced by a plant nursery for commercial gardeners, etc.

The term “contained basic plant” refers herein to a plant being contained in a raw container, produced by a plant nursery for commercial gardeners, etc.

In one aspect of the invention, the invention provides a method and apparatus for producing contained basic plants through a combination of manual and automatic operations, being suited for employing impaired persons.

In one aspect of the invention, the invention provides a solution to the above-mentioned and other problems of the prior art.

### SUMMARY

In one aspect, the invention is directed to a working station (10), comprising:
a base (44);
a table (72), extending from the base (44), the table (72) comprising at least two subsidiary tables (96A, 96B, 96C, 96D),

wherein each of the at least two subsidiary tables (96A, 96B, 96C, 96D) is independently tiltable and elevatable in relation to the base (44),

thereby the at least two subsidiary tables (96A, 96B, 96C, 96D) are adaptable for impaired persons.

### BRIEF DESCRIPTION OF THE DRAWINGS

Embodiments, features, and aspects of the invention are described herein in conjunction with the following drawings:

FIG. 1 is a front perspective view of a working station, according to one embodiment of the invention.

FIG. 2 is a schematic diagram of the working station of FIG. 1.

FIG. 3 is a front perspective view of the working station of FIG. 1, upon adapting the plurality of subsidiary tables, each for a different worker.

FIG. 4 is a front perspective view of the working station of FIG. 1, upon adapting the plurality of subsidiary tables, including connections between the various subsidiary tables.

FIG. 5 is a side view of two adjacent subsidiary tables having the stretchable substrate of FIG. 4 therebetween.

FIG. 6 is a side view of two adjacent subsidiary tables being horizontally spaced, and having the stretchable substrate of FIG. 4 therebetween.

FIG. 7 is a side view of two adjacent subsidiary tables being horizontally spaced, and showing the fixing of the stretchable substrate of FIG. 4 thereto.

FIG. 8 is a bottom perspective view of the working station of FIG. 1. The drawings are not necessarily drawn to scale.

### DETAILED DESCRIPTION

The invention will be understood from the following detailed description of embodiments of the invention, which are meant to be descriptive and not limiting. For the sake of brevity, some well-known features, methods, systems, procedures, components, circuits, and so on, are not described in detail.

The reference numbers have been used to point out elements in the embodiments described and illustrated herein, in order to facilitate the understanding of the invention. They are meant to be merely illustrative, and not limiting. Also, the foregoing embodiments of the invention have been described and illustrated in conjunction with systems and methods thereof, which are meant to be merely illustrative, and not limiting.

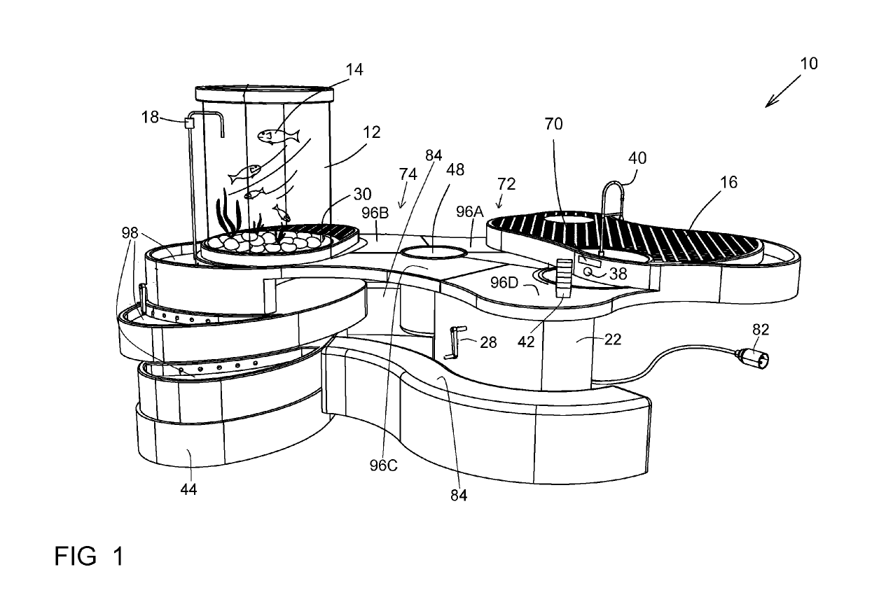

FIG. 1 is a front perspective view of a working station, according to one embodiment of the invention.

A working station 10 is intended for applying manual work, accompanied by automatic procedures, for filling a plurality of cups 42 with seeds or plants 46 and with additional ingredients, for making the initial growing.

Production of contained basic plants may be used for employing impaired persons.

Working station 10 may include a table 72, extending from a base 44, for placing cups 42 on the table; and seats 80 for the workers.

Table 72, extending from base 44, may include a plurality of subsidiary tables, namely 96A, 96B, 96C and 96D, each for a different worker.

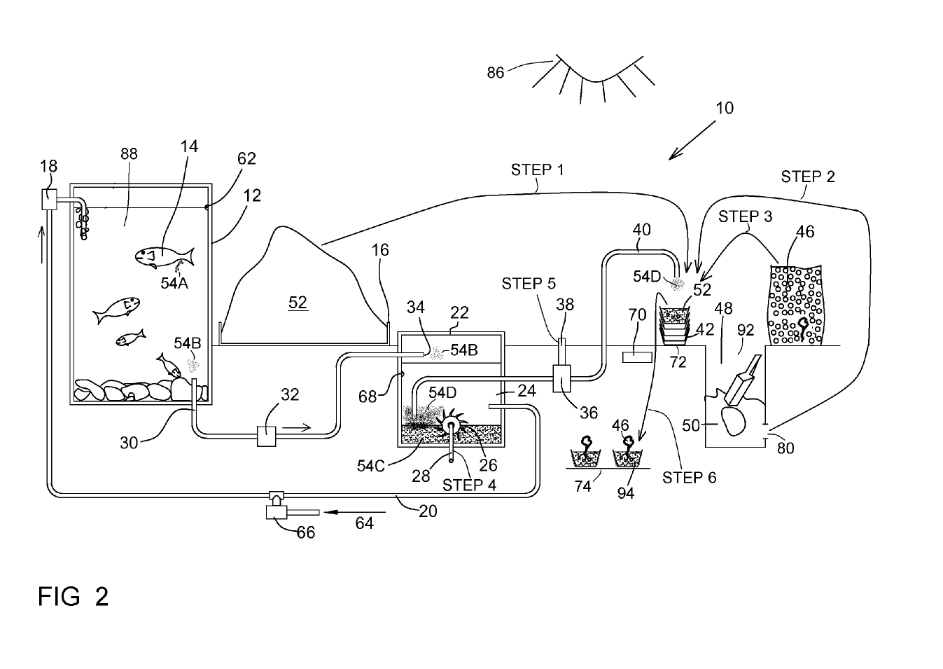

FIG. 2 is a schematic diagram of the working station of FIG. 1.

At the first step, the worker may take sand 52 from a sand storage 16, and may fill a sand dose into the cup 42.

At the second step, the worker places seeds or plants 46 into cup 42.

Working station 10 includes compost ingredients, being prepared by the station.

The first compost ingredient is prepared by a compost bin 48, by the sun 86, and by waste being placed many days before the current filling, by the workers into the top opening 92 thereof.

At the third step, the worker digs compost 50 from the bottom opening 80 of compost bin 48.

The second compost ingredient is prepared by an aquarium 12 containing fish 14 producing feces 54A, being mixed with the water 88, thus forming a liquidized feces mixture 54B. sinking to the bottom of aquarium 12.

A water pump 32 diligently draws water through a pipe 30 from the bottom of aquarium 12, thus containing liquidized feces mixture 54B, to a water container 22. A second pump 18 returns clean water 24 from water container 22 back to aquarium 12.

Consequently, the bottom of container 22 receives feces 54C being accumulated from mixture 54B by pumps 32 and 18.

At the fourth step, the worker checks that the bottom of water container 22 contains enough fish feces 54C, and if positive, may mix it with the water disposed thereabove, by a mixing tool 26, which may be operated manually by a handle 28, for obtaining a mixture 54D having a selected concentration extent, which may be viewed by a viewing window 70. Liquidized feces mixture 54D in container 22 is significantly more concentrated than mixture 54B in aquarium 12.

At the fifth step, the worker operates a water pump 36, which may be electric or mechanic, for drawing a portion from the mixture 54D, for administering it into cup 42. This step as well irrigates plant or seed 46.

The manual drawing of mixture 54D, lessens the overall amount of water in the closed water system, and thus may invite the worker to open a tap 66 for adding water to the system from an external water source, such as from the water grid supply 64. According to one embodiment, the opening of tap 66 may be applied automatically.

However, the manual operation is preferred, also for other characteristics of working station 10, since working station 10 may be intended for keeping impaired/disabled persons, being the workers of the station, busy, by providing easy tasks, followed by automatic operations of working station, such as by pumps 18 and 32.

At the sixth step, the worker takes the cup 42 being filled, thus being a basic contained plant 94, from table portion 72 to table portion 74, where the basic contained plants 94 are disposed, for filling the next empty cup 42.

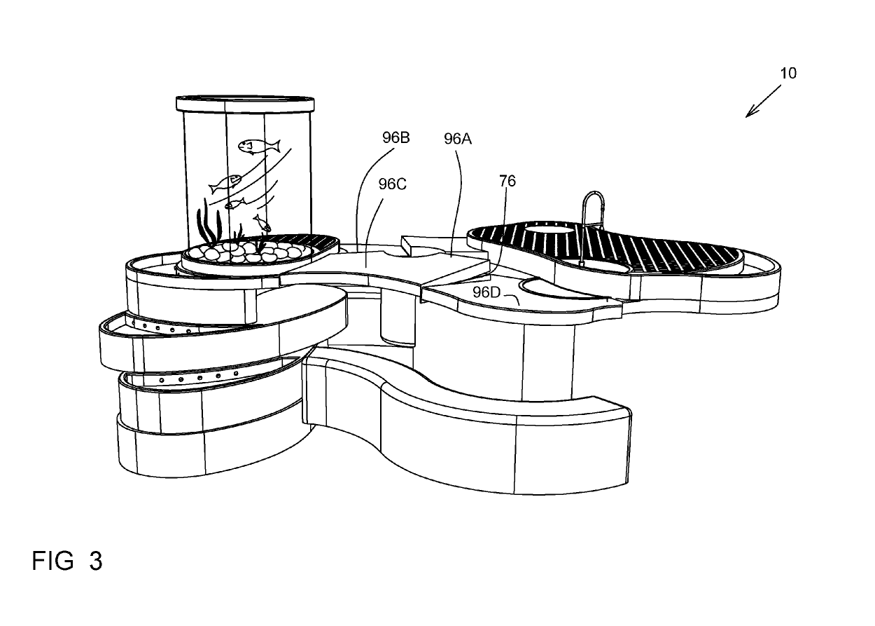

FIG. 3 is a front perspective view of the working station of FIG. 1, upon adapting the plurality of subsidiary tables, each for a different worker.

Each of subsidiary tables 96A, 96B, 96C and 96D is tiltable in relation to base 44, thus being independently tiltable one from the other, for being adapted to the impaired person working thereon.

Each of subsidiary tables 96A, 96B, 96C and 96D is further elevatable in relation to base 44, thus being independently elevatable one from the other, for further being adapted to the impaired person working thereon. For example, subsidiary table 96A is depicted in the figure as being higher than the other subsidiary tables.

The tilting and the elevating of each subsidiary table may be motorized or manual.

However, the tilting and the elevating of two adjacent subsidiary tables, for example of 96A in relation to 96D, forms undesirable spaces 76 therebetween, into which items and dirt may fall. This is crucial regarding the work with the sand, water, compost being the issue of the working station.

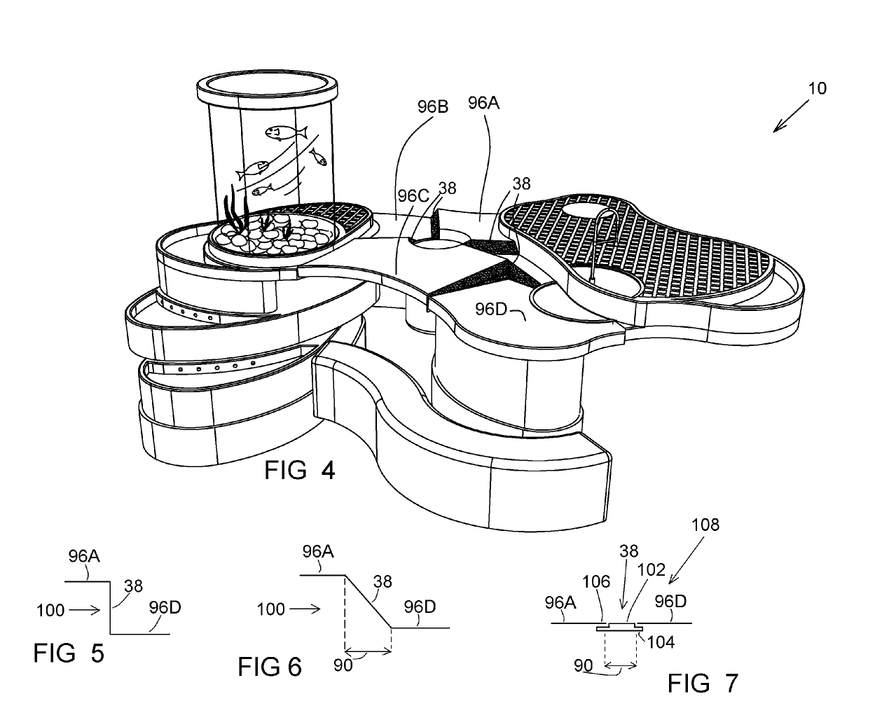

FIG. 4 is a front perspective view of the working station of FIG. 1, upon adapting the plurality of subsidiary tables, including connections between the various subsidiary tables.

A stretchable substrate 38 may be deployed between adjacent subsidiary tables, for example between subsidiary tables 96A and 96D, for providing gradual change of the height therebetween.

FIG. 5 is a side view of two adjacent subsidiary tables having the stretchable substrate of FIG. 4 therebetween.

However, even though stretchable substrate 38 closes the vertical gap 100 between the subsidiary tables 96A and 96D, yet the change might not be gradual, as depicted by stretchable substrate 38 being positioned vertically.

FIG. 6 is a side view of two adjacent subsidiary tables being horizontally spaced, and having the stretchable substrate of FIG. 4 therebetween.

Adjacent subsidiary tables 96A and 96D may preferable be horizontally spaced therebetween by a horizontal spacing 90, for making the change between the subsidiary tables gradual. Thus, instead of the vertical positioning of stretchable substrate 38 of FIG. 4, stretchable substrate 38 in FIG. 5 is shown in a 45 degrees angle, providing the gradual change.

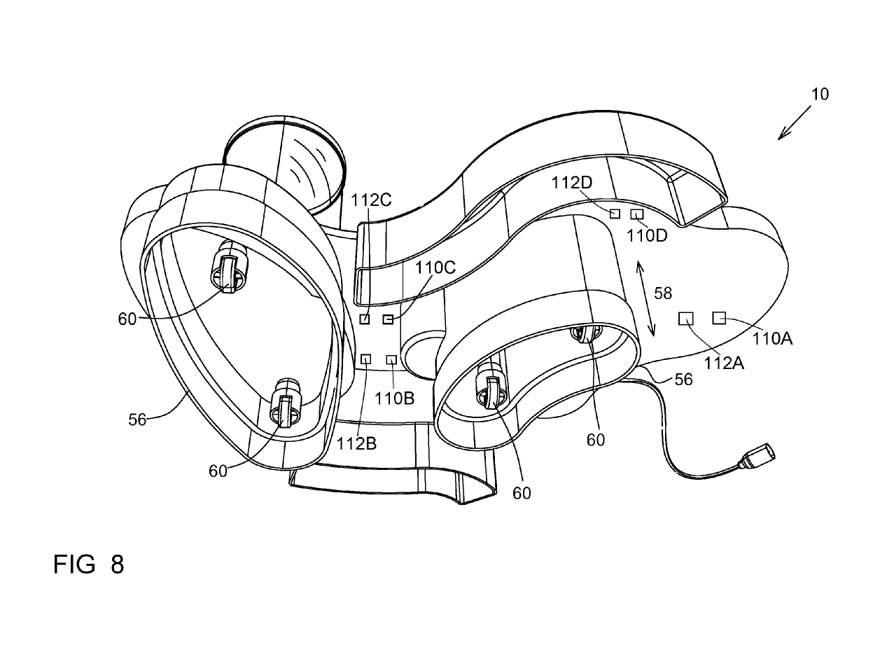

FIG. 7 is a side view of two adjacent subsidiary tables being horizontally spaced, and showing the fixing of the stretchable substrate of FIG. 4 thereto.

Stretchable substrate 38 should provide a smooth unified surface 108 together with adjacent subsidiary tables 96A and 96D, and thus, ends 104 of stretchable substrate 38 may be fixed to the bottom ends 106 of subsidiary tables 96A and 96D, and the center portion 102, covering horizontal spacing 90, may be thicker than ends 104.

FIG. 8 is a bottom perspective view of the working station of FIG. 1.

Working station 10 may include wheels 60 for changing the location thereof, for being shaded or for being illuminated by the sun.

A motor 110A may operate for tilting subsidiary table 96A; and a motor 112A may operate for elevating and for lowering subsidiary table 96A. A motor 110B may operate for tilting subsidiary table 96B; and a motor 112B may operate for elevating and for lowering subsidiary table 96B. A motor 110C may operate for tilting subsidiary table 96C; and a motor 112C may operate for elevating and for lowering subsidiary table 96C. A motor 110D may operate for tilting subsidiary table 96D; and a motor 112D may operate for elevating and for lowering subsidiary table 96D.

Thus, in one aspect, the invention is directed to a working station (10), comprising:
a base (44);
a table (72), extending from the base (44), the table (72) comprising at least two subsidiary tables (96A, 96B, 96C, 96D),

wherein each of the at least two subsidiary tables (96A, 96B, 96C, 96D) is independently tiltable and elevatable in relation to the base (44),

thereby the at least two subsidiary tables (96A, 96B, 96C, 96D) are adaptable for impaired persons.

The working station (10) may further include:
a stretchable sheet (38) deployed between at least adjacent ends (106) of the at least two subsidiary tables (96A, 96B, 96C, 96D),

thereby forming the at least two subsidiary tables (96A, 96B, 96C, 96D) to be a unified surface.(108).

The working station (10) may further include:
a horizontal spacing (90) between the at least two subsidiary tables (96A, 96B, 96C, 96D); and
a stretchable sheet (38) deployed between at least adjacent ends (106) of the at least two subsidiary tables (96A, 96B, 96C, 96D),

thereby forming the at least two subsidiary tables (96A, 96B, 96C, 96D) to be a unified surface.(108).

Each of the at least two subsidiary tables (96A, 96B, 96C, 96D) may include a separate motor for tilting thereof.

Each of the at least two subsidiary tables (96A, 96B, 96C, 96D) may include a separate motor for elevating thereof.

In another aspect, the invention is directed to a working station (10), for producing contained basic plants (94), the working station (10) including a compost assembly including:
an aquarium (12) for containing fish (14) for producing a liquidized feces mixture (54B, 54D) therefrom; and
administering means (36), for administering the liquidized feces mixture (54D) into cups (42) containing plants (46).

The working station (10) may further include:
a water container (22),

for receiving the liquidized feces mixture (54B) from the aquarium (12), and for removing water from the received liquidized feces mixture (54B), for returning the removed water into the aquarium (12),

thereby accumulating fish feces (54C) in the water container (22), from the received liquidized feces mixture (54B).

The working station (10) may further include:
a mixing element (26), disposed in the water container (22), for mixing the accumulated fish feces (54C) with water of the water container (22), for producing the liquidized feces mixture (54D),

thereby obtaining a concentrated liquidized feces mixture (54D).

The compost assembly may further include a compost bin (48) including:
a top opening (92), for inserting waste thereinto, and
a bottom opening (80) for removing compost therefrom.

The compost assembly may further include:
a working table (72), for filling cups (42) with plants (46), to be administered by the liquidized feces mixture (54B, 54D).

The compost assembly may further include
a working table (72), sized for being portable,

thereby allowing changing the location thereof, for being shaded or for being illuminated by the sun (86), for growing the contained basic plants (94).

In another aspect, the invention is directed to a method for producing contained basic plants (94), the method the steps of:
providing an aquarium (12) for containing fish (14) for producing a liquidized feces mixture (54B, 54D) therefrom; and
administering the liquidized feces mixture (54D) into cups (42) containing plants (46).

The method may further include the steps of:
receiving the liquidized feces mixture (54B) from the aquarium (12) into a water container (22);
removing water from the received liquidized feces mixture (54B); and
returning the removed water into the aquarium (12),

thereby accumulating fish feces (54C) in the water container (22), from the received liquidized feces mixture (54B).

The method may further include the step of:

mixing the accumulated fish feces (54C) with water of the water container (22), for producing the liquidized feces mixture (54D),

thereby obtaining a concentrated liquidized feces mixture (54D).

In the figures and/or description herein, the following reference numerals (Reference Signs List) have been mentioned:
numeral 10 denotes the working station, according to one embodiment of the invention;
numeral 12 denotes an aquarium;
numeral 14 denote fish;
numeral 16 denotes a sand storage having a sieve at the bottom thereof, for allowing the sand remainder to drop thereunder;
numeral 18 denotes a water pump;
numeral 20 denotes a water pipe;
numeral 22 denotes a water container;
numeral 24 denotes water contained in the water container;
numeral 26 denotes a mixing tool;
numeral 28 denotes a handle;
numeral 30 denotes a water pipe;
numeral 32 denotes a water pump;
numeral 34 denotes an outlet of a water pipe;
numeral 36 denotes a water pump;
numeral 38 denotes a button for operating a water pump;
numeral 40 denotes a water pipe;
numeral 42 denotes a cup for containing a plant or seeds;
numeral 44 denotes the base of the table;
numeral 46 denotes a plant or a seed for being inserted into the cup;
numeral 48 denotes a compost bin;
numeral 50 denotes compost produced by the compost bin;
numeral 52 denotes sand for growing the plant;
numeral 54A denotes fish feces;
numeral 54B denotes liquidized feces mixture, produced by natural diffusion of the fish feces in the water of the aquarium;
numeral 54C denotes fish feces, produced upon removal of water from the liquidized feces mixture;
numeral 54D denotes liquidized feces mixture, produced by forced mixing of the fish feces with water in the water container;
numeral 56 denotes a slideable support of the working table;
numeral 58 denotes an arrow indicating the slideability of the slideable support of the working table;
numeral 60 denotes a wheel of the working table;
numeral 62 denotes a water level sensor, for sensing the water level in the aquarium, for maintaining a constant water level;
numeral 64 denotes the water grid supply, for maintaining the constant water level in the aquarium;
numeral 66 denotes a tap;
numeral 68 denotes a sensor, disposed in the water container, for measuring the concentration extent of the feces mixture;
numeral 70 denotes a window, or a screen, for viewing the concentration extent;
numerals 72 and 74 denotes portions of the working table;
numeral 76 denotes a space between two adjacent subsidiary tables;
numeral 80 denotes the bottom opening of the compost bin;
numeral 82 denotes a power plug;
numeral 84 denotes seats;
numeral 86 denotes the sun;
numeral 88 denotes the water in the aquarium;
numeral 90 denotes a horizontal spacing, being the distance between two adjacent subsidiary tables;
numeral 92 denotes the top opening of the compost bin;
numeral 94 denotes a basic contained plant, being the basic plant including the cup;
numerals 96A, 96B, 96C and 96D denote subsidiary tables, each being tiltable and elevatable, independently one from the other;
numeral 98 denotes a compartment, for growing plants therein; the compartment is stationary, in relation to the entire workstation, in contrast to cups 42;

The foregoing description and illustrations of the embodiments of the invention has been presented for the purposes of illustration. It is not intended to be exhaustive or to limit the invention to the above description in any form.

Any term that has been defined above and used in the claims, should to be interpreted according to this definition.

The reference numbers in the claims are not a part of the claims, but rather used for facilitating the reading thereof. These reference numbers should not be interpreted as limiting the claims in any form.

What is claimed is:

1. A working station, comprising:
a base;
a table, extending from said base, said table comprising at least two subsidiary tables, wherein each of said at least two subsidiary tables is independently tiltable and elevatable in relation to said base,
thereby said at least two subsidiary tables are adaptable for impaired persons.

2. A working station according to claim 1, further comprising:
a stretchable sheet deployed between at least adjacent ends of said at least two subsidiary tables,
thereby forming said at least two subsidiary tables to be a unified surface.

3. A working station according to claim 1, further comprising:
a horizontal spacing between said at least two subsidiary tables; and
a stretchable sheet deployed between at least adjacent ends of said at least two subsidiary tables,
thereby forming said at least two subsidiary tables to be a unified surface.

4. A working station according to claim 1, wherein each of said at least two subsidiary tables comprises a separate motor for tilting thereof.

5. A working station according to claim 1, wherein each of said at least two subsidiary tables comprises a separate motor for elevating thereof.
